(19) United States
(12) Patent Application Publication
(10) Pub. No.: US 2026/0313479 A1
(43) Pub. Date: Oct. 8, 2026

(54) HANDOVER METHOD AND APPARATUS

(71) Applicant: Electronics and Telecommunications Research Institute, Daejeon (KR)

(72) Inventors: Hyun Seo PARK, Daejeon (KR); Yong Jin KWON, Daejeon (KR); Yunjoo KIM, Daejeon (KR); Seungjae BAHNG, Daejeon (KR); Jungbo SON, Daejeon (KR); Youngjoon YOON, Daejeon (KR); Anseok LEE, Daejeon (KR); Yu Ro LEE, Daejeon (KR); Jungsook BAE, Daejeon (KR); Heesoo LEE, Daejeon (KR)

(21) Appl. No.: 19/457,030

(22) Filed: Jan. 22, 2026

(30) Foreign Application Priority Data
Jan. 22, 2025 (KR) 10-2025-0009681
Jul. 30, 2025 (KR) 10-2025-0104553

(51) Int. Cl. H04W 36/00

(52) U.S. Cl. CPC H04W 36/0058

(57) ABSTRACT

A method of a terminal may comprise: receiving measurement configuration information from a base station; receiving measurement prediction configuration information from the base station; receiving measurement prediction report event configuration information from the base station; performing measurement on a serving cell and neighboring cells based on the measurement configuration information to generate measurement results; performing measurement prediction on the serving cell and the neighboring cells based on the measurement prediction configuration information to generate measurement prediction results; determining whether a measurement prediction report is required based on the measurement prediction results according to the measurement prediction report event configuration information; and transmitting, to the base station, a measurement prediction report including the measurement prediction results based on whether the measurement prediction report is required.

### CROSS-REFERENCE TO RELATED APPLICATIONS

This application claims priority to Korean Patent Applications No. 10-2025-0009681, filed on Jan. 22, 2025, and No. 10-2025-0104553, filed on Jul. 30, 2025, with the Korean Intellectual Property Office (KIPO), the entire contents of which are hereby incorporated by reference.

### BACKGROUND

### 1. Technical Field

The present disclosure relates to a handover technique, and more particularly, to a handover technique based on measurement prediction.

### 2. Related Art

A communication network (e.g. 5G communication network, 6G communication network, and the like) for providing improved communication services compared to an existing communication network (e.g. long term evolution (LTE), LTE Advanced (LTE-A), and the like) is being developed. The 5G communication network (e.g. new radio (NR) communication network) can support frequency bands of 6 GHz or lower as well as frequency bands above 6 GHz. In other words, the 5G communication network can support frequency range 1 (FR1) and/or frequency range 2 (FR2). The 5G communication network can support various communication services and scenarios compared to the LTE communication network. For example, usage scenarios of the 5G communication network may include enhanced Mobile Broadband (eMBB), Ultra-Reliable Low Latency Communication (URLLC), and massive Machine Type Communication (mMTC).

A handover may be a procedure for switching a base station (or a cell) connected to a terminal to another base station (or another cell) so that data transmission is not interrupted. The handover procedure may be briefly described as follows. When an event occurs, the terminal may transmit a measurement report to a source base station. As factors for defining the occurrence of the event, time to trigger (TTT) and an offset may be considered. The source base station may determine a target base station based on the measurement report. The target base station may transmit a handover command to the terminal via the source base station. After receiving the handover command, the terminal may establish a connection with the target base station.

As generations of mobile communication progress, more base stations (or cells) may be densely deployed in a narrow area in order to increase user-perceived data rate. Due to the dense deployment of base stations, the number of neighboring cells capable of providing a signal having better quality than that of a serving cell to the terminal may increase in an area where handover is likely to occur. When the number of neighboring cells capable of providing a signal having better quality than that of the serving cell increases, the terminal may perform a large number of handovers within a short time. When a large number of handovers are performed within a short time, a problem may occur in that the user experiences an increased number of interruptions caused by the handovers.

### SUMMARY

A method of a terminal, according to exemplary embodiments of the present disclosure, may comprise: receiving measurement configuration information from a base station; receiving measurement prediction configuration information from the base station; receiving measurement prediction report event configuration information from the base station; performing measurement on a serving cell and neighboring cells based on the measurement configuration information to generate measurement results; performing measurement prediction on the serving cell and the neighboring cells based on the measurement prediction configuration information to generate measurement prediction results; determining whether a measurement prediction report is required based on the measurement prediction results according to the measurement prediction report event configuration information; and transmitting, to the base station, a measurement prediction report including the measurement prediction results based on whether the measurement prediction report is required.

The method may further comprise: before generating the measurement prediction results, configuring a first condition included in the measurement prediction configuration information, the first condition being a condition for performing the measurement prediction; and determining whether the first condition is satisfied, wherein the measurement prediction results may be generated based on whether the first condition is satisfied.

The first condition may be satisfied based on that the measurement results satisfy a second condition.

The second condition may be satisfied based on that the measurement results satisfy an entering condition of a measurement report event indicated by the measurement report event configuration information.

The method may further comprise: before transmitting the measurement prediction report, determining whether a third condition included in the measurement prediction configuration information is satisfied, wherein the measurement prediction report may be transmitted based on satisfaction of the third condition.

The third condition may be satisfied based on that the measurement results and the measurement prediction results satisfy a fourth condition.

The measurement prediction report may include at least one of whether a measurement report event indicated by the measurement report event configuration information is satisfied or a time at which the measurement report event is satisfied.

The method may further comprise: receiving, from the base station, a handover command based on the measurement prediction report; checking whether satisfaction of the first condition is maintained for a first time; and performing a handover according to the handover command based on whether the satisfaction of the first condition is maintained for the first time.

A method of a base station, according to exemplary embodiments of the present disclosure, may comprise: transmitting, to a terminal, measurement configuration information including measurement report event configuration information; transmitting measurement prediction configuration information to the terminal; receiving, from the terminal, a measurement prediction report including measurement prediction results generated based on the measurement prediction configuration information; and transmitting a handover command to the terminal based on the measurement prediction results.

The measurement prediction configuration information may include a first condition for the terminal to perform measurement prediction, and the measurement prediction results may be generated based on satisfaction of the first condition.

The first condition may be satisfied based on that measurement results generated based on the measurement configuration information satisfy a second condition.

The second condition may be satisfied based on that the measurement results satisfy an entering condition of a measurement report event indicated by the measurement report event configuration information.

The measurement prediction configuration information may include a third condition, and the measurement prediction report may be received based on satisfaction of the third condition.

The third condition may be satisfied based on that the measurement results and the measurement prediction results satisfy a fourth condition.

The measurement prediction report may include at least one of whether a measurement report event indicated by the measurement report event configuration information is satisfied or a time at which the measurement report event is satisfied.

A terminal according to exemplary embodiments of the present disclosure may comprise at least one processor, wherein the at least one processor may cause the terminal to perform: receiving measurement configuration information from a base station; receiving measurement prediction configuration information from the base station; receiving measurement prediction report event configuration information from the base station; performing measurement on a serving cell and neighboring cells based on the measurement configuration information to generate measurement results; performing measurement prediction on the serving cell and the neighboring cells based on the measurement prediction configuration information to generate measurement prediction results; determining whether a measurement prediction report is required based on the measurement prediction results according to the measurement prediction report event configuration information; and transmitting, to the base station, a measurement prediction report including the measurement prediction results based on whether the measurement prediction report is required.

The at least one processor may further cause the terminal to perform: before generating the measurement prediction results, determining whether a first condition included in the measurement prediction configuration information is satisfied, wherein the first condition may be a condition for performing the measurement prediction, and the measurement prediction results may be generated based satisfaction of the first condition.

The first condition may be satisfied based on that the measurement results satisfy a second condition.

The second condition may be satisfied based on that the measurement results satisfy an entering condition of a measurement report event indicated by the measurement report event configuration information.

The at least one processor may further cause the terminal to perform: before transmitting the measurement prediction report, determining whether a third condition included in the measurement prediction configuration information is satisfied; and determining whether the measurement prediction report is required for the base station, wherein the measurement prediction report may be transmitted based on satisfaction of the third condition and based on the measurement prediction report being required for the base station

According to the present disclosure, a base station may transmit measurement prediction configuration information and/or measurement prediction report configuration information to a terminal through a radio resource control (RRC) reconfiguration message. Determination of whether a measurement prediction report event is satisfied based on an event window may be configured in the terminal through the above-described measurement prediction configuration information and/or the measurement prediction report configuration information. Determination of whether a measurement prediction report event is satisfied based on the event window may refer to an operation of the terminal as follows. After receiving the above-described measurement prediction configuration information, the terminal may identify a start time and an end time of the event window. After identifying the start time and the end time of the event window, the terminal may determine whether a duration during which an event trigger condition corresponding to the measurement prediction report event exceeds a threshold within the event window. When the duration during which the event trigger condition is satisfied exceeds the threshold, the terminal may determine that the measurement prediction report event is satisfied. The terminal may avoid transmitting unnecessary measurement prediction reports through the above-described procedures. By avoiding transmission of unnecessary measurement prediction reports, unnecessary handovers may be avoided. When unnecessary handovers are avoided, interruption time between the terminal and a cell may be reduced.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a graph illustrating exemplary embodiments of RSRP values over time.

FIG. 4 is a graph illustrating exemplary embodiments of RSRP values over time.

FIG. 5 is a sequence diagram illustrating exemplary embodiments of a measurement prediction-based handover procedure.

FIG. 6 is a sequence diagram illustrating exemplary embodiments of a measurement prediction-based handover procedure.

FIG. 7 is a sequence diagram illustrating exemplary embodiments of a measurement prediction-based handover procedure.

FIG. 8A is a sequence diagram illustrating exemplary embodiments of a measurement prediction-based handover procedure.

FIG. 8B is a sequence diagram illustrating exemplary embodiments of a measurement prediction-based handover procedure.

FIG. 9A is a sequence diagram illustrating exemplary embodiments of a measurement prediction-based handover procedure.

FIG. 9B is a sequence diagram illustrating exemplary embodiments of a measurement prediction-based handover procedure.

FIG. 10 is a timing diagram illustrating exemplary embodiments of a measurement report procedure.

FIG. 11 is a timing diagram illustrating exemplary embodiments of a measurement prediction-based handover procedure.

FIG. 12 is a timing diagram illustrating exemplary embodiments of a measurement prediction-based handover reliability improvement procedure.

FIG. 13 is a timing diagram illustrating exemplary embodiments of a measurement prediction-based handover reliability improvement procedure.

FIG. 14 is a timing diagram illustrating exemplary embodiments of a measurement prediction-based handover reliability improvement procedure.

FIG. 15 is a timing diagram illustrating exemplary embodiments of a measurement prediction-based handover reliability improvement procedure.

FIG. 16 is a conceptual diagram illustrating exemplary embodiments of blocks included in a terminal.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication network (or communication system) to which exemplary embodiments according to the present disclosure are applied will be described. The communication network to which exemplary embodiments according to the present disclosure are applied is not limited to the content described below, and the exemplary embodiments according to the present disclosure can be applied to various communication networks. Here, the term ‘communication network’ may be used interchangeably with ‘communication system’. The communication network may refer to a wireless communication network, and the communication system may refer to a wireless communication system.

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, signaling may be at least one of System Information (SI) signaling (e.g. transmission of System Information Block (SIB) and/or Master Information Block (MIB)), RRC signaling (e.g. transmission of RRC parameters and/or higher-layer parameters), MAC Control Element (CE) signaling, or PHY signaling (e.g. transmission of Downlink Control Information (DCI), Uplink Control Information (UCI), and/or Sidelink Control Information (SCI).

The names of frames proposed in the present disclosure may be generalized as a first frame, a second frame, a third frame, and the like. In the present disclosure, a transmission time may refer to a start time of frame transmission and/or an end time (e.g. completion time) of frame transmission, while a reception time may refer to a start time of frame reception and/or an end time (e.g. completion time) of frame reception. The term ‘time’ may be interpreted as a time point depending on a context.

In the present disclosure, a phrase including “when ~” may be expressed as a phrase including “based on ~” or a phrase including “in response to ~”. In other words, a phrase including “when ~” may be interpreted as being the same as or similar to a phrase including “based on ~” or a phrase including “in response to ~”.

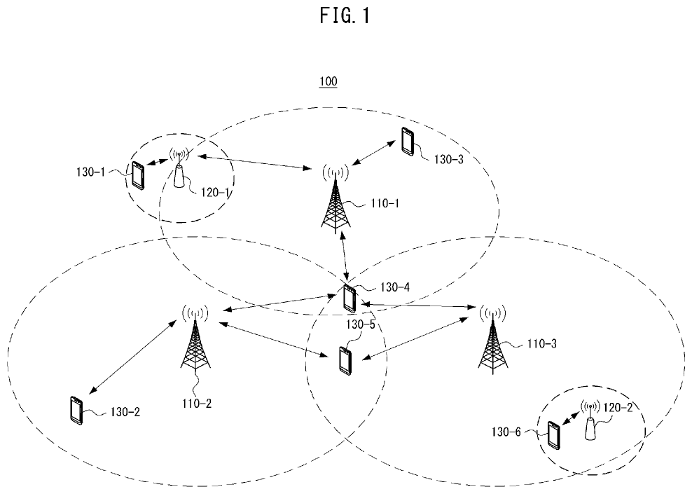

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have a structure below.

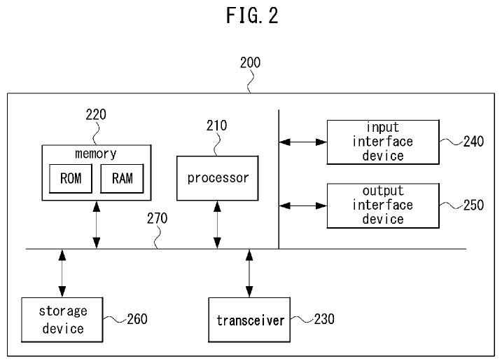

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multi-hop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication network will be described. Even when a method (e.g. transmission or reception of a signal) to be performed at a first communication node among communication nodes is described, a corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

A brief description of a handover procedure is provided below. A handover procedure may be performed for mobility management of a terminal in a radio resource control (RRC) connected state. The terminal may perform measurements on a serving cell and/or neighboring cells. The terminal may determine whether a measurement report event is satisfied based on one or more measurement results. The measurement report event may be an A3 event. In the present disclosure, a measurement report event may refer to a condition that should be satisfied to trigger transmission of a measurement report, and a measurement prediction report event may refer to a condition that should be satisfied to trigger transmission of a measurement prediction report. A measurement prediction report may include at least one of one or more predicted triggering quantity values (e.g. reference signal received power (RSRP), reference signal received quality (RSRQ), signal to interference plus noise ratio (SINR), or signal to noise ratio (SNR)), a type of a predicted measurement report event, information indicating whether a measurement report event is satisfied, or information indicating a time at which the measurement report event is satisfied. In the present disclosure, an event trigger condition may refer to a condition that should be satisfied for a measurement report event and/or a measurement prediction report event. When a signal strength (e.g. RSRP) of a neighboring cell is higher than that of a serving cell by at least a handover (HO) margin and the state is maintained during TTT, an A3 event may be satisfied. When the terminal determines that the measurement report event is satisfied, the terminal may transmit a measurement report to a source base station (or a source cell).

The source base station receiving the measurement report may determine a target base station (or a target cell). After determining the target base station, the source base station may transmit a handover request message to the target base station. After receiving the handover request message, the target base station may perform handover admission control. After performing the handover admission control, the target base station may transmit a handover request acknowledge (ACK) message to the source base station. After receiving the handover request ACK message, the source base station may transmit a handover command to the terminal. After transmitting the handover command, the source base station may release the connection with the terminal. After releasing the connection with the terminal, the source base station may forward data received from the terminal to the target base station.

The terminal receiving the handover command may release the connection with the source base station. After releasing the connection with the source base station, the terminal may acquire downlink synchronization with the target cell. After acquiring the downlink synchronization, the terminal may attempt access to the target cell through a random access procedure. The terminal completing the random access procedure may transmit a handover completion message to the target base station.

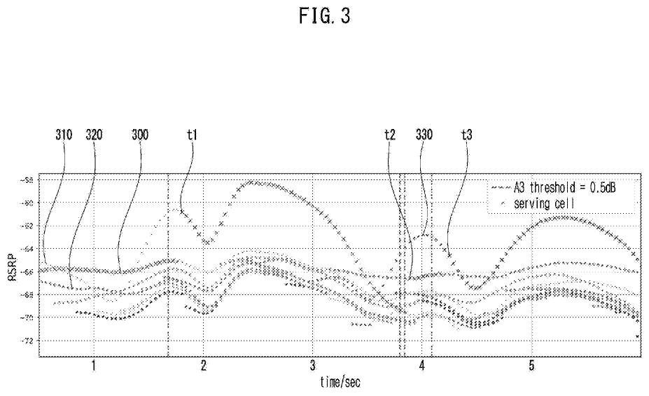

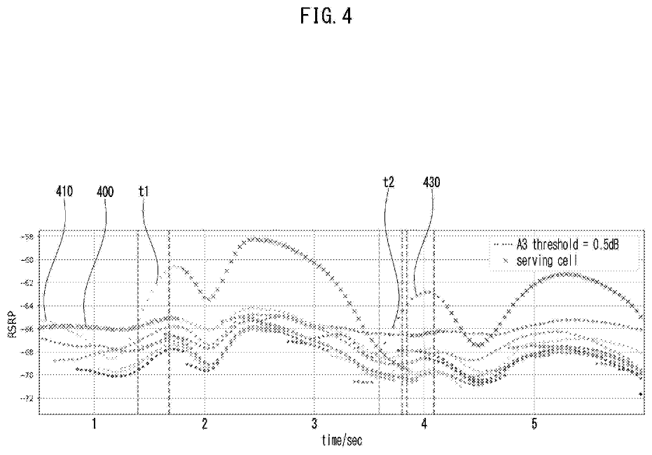

As generations of mobile communication progress, a large number of base stations may be installed in a narrow area. Since a large number of base stations are installed in a narrow area, the number of neighboring cells having a signal strength higher than that of a serving cell may be large in an area where handover of the terminal is initiated. As the number of neighboring cells having a signal strength better than the signal strength of the serving cell increases, the number of measurement reports transmitted by the terminal may increase. In addition, as the number of neighboring cells having a signal strength higher than that of the serving cell increases, another handover may be initiated within a short time after completion of a handover procedure. Due to unnecessary handover procedures and an increase in measurement report transmissions of the terminal, a user may experience communication interruption time. Graphs according to exemplary embodiments illustrated in FIG. 3 and FIG. 4 may respectively reflect a situation in which the above-described problem occurs and a situation in which the problem is resolved.

FIG. 3 is a graph illustrating exemplary embodiments of RSRP values over time.

Referring to FIG. 3, signal strength measurement results of a serving cell and neighboring cells obtained in a simulation environment for a terminal (e.g. unmanned aerial vehicle (UAV)) located at an altitude of 50 meters and moving at a speed of 44 m/s may be identified. At times indicated by vertical dotted lines, the terminal may transmit measurement reports to a base station. The terminal may perform handovers at times t1, t2, and t3. A signal strength indicated by X may represent a signal strength of the serving cell.

The terminal may obtain an RSRP 310 of a first neighboring cell through measurement on the first neighboring cell. The terminal may obtain an RSRP 300 of the serving cell through measurement on the serving cell. The terminal may compare the RSRP 310 of the first neighboring cell and the RSRP 300 of the serving cell. The terminal may determine whether an A3 event is satisfied based on a comparison result between the RSRP 310 of the first neighboring cell and the RSRP 300 of the serving cell. A first measurement report from the left may be transmitted by the terminal at a time at which the A3 event is satisfied based on the comparison result between the RSRP 310 of the first neighboring cell and the RSRP 300 of the serving cell. A condition that should be satisfied for the A3 event may be that a signal strength of a neighboring cell is higher than that of the serving cell by an offset. A source base station receiving the first measurement report may determine the first neighboring cell as a target cell. The terminal may perform a handover to the first neighboring cell.

The terminal may obtain an RSRP 320 of a second neighboring cell through measurement on the second neighboring cell. The terminal may obtain an RSRP 310 of the serving cell through measurement on the serving cell. The terminal may compare the RSRP 320 of the second neighboring cell and the RSRP 310 of the serving cell. The terminal may determine whether an A3 event is satisfied based on a comparison result between the RSRP 320 of the second neighboring cell and the RSRP 310 of the serving cell. A second measurement report from the left may be transmitted by the terminal at a time at which the A3 event is satisfied based on the comparison result between the RSRP 320 of the second neighboring cell and the RSRP 310 of the serving cell. A third measurement report from the left may be transmitted at a time at which an A3 event is satisfied based on a comparison between an RSRP 330 of a third neighboring cell and an RSRP 310 of the serving cell and based on the A3 event. At a time at which the second measurement report is transmitted, a cell having the best signal strength may correspond to the third neighboring cell. The source base station receiving the second measurement report may determine the second neighboring cell as a target cell. The terminal may perform a handover to the second neighboring cell. Since the handover to the second neighboring cell is determined at a time at which the third measurement report is transmitted, the third measurement report may not be successfully received by the source base station of which the second neighboring cell.

The terminal may obtain an RSRP 320 of the serving cell through measurement on the serving cell. The terminal may obtain an RSRP 330 of the third neighboring cell through measurement on the third neighboring cell. The terminal may compare the RSRP 320 of the serving cell and the RSRP 330 of the third neighboring cell. The terminal may determine whether an A3 event is satisfied based on a comparison result between the RSRP 320 of the serving cell and the RSRP 330 of the third neighboring cell. A fourth measurement report from the left may be transmitted by the terminal at a time at which the A3 event is satisfied based on the comparison result between the RSRP 320 of the serving cell and the RSRP 330 of the third neighboring cell. The source base station receiving the fourth measurement report may determine the third neighboring cell as a target cell. The terminal may perform a handover to the third neighboring cell. A short time interval may exist between the handover performed at the time t2 and the handover performed at the time t3. The handover performed at the time t2 may be evaluated as an unnecessary handover. The second measurement report and the third measurement report transmitted due to the unnecessary handover may be evaluated as unnecessary measurement reports. Unnecessary handovers and unnecessary measurement reports may result in waste of radio resources and signaling overhead.

FIG. 4 is a graph illustrating exemplary embodiments of RSRP values over time.

Referring to FIG. 4, two vertical dotted lines may be identified. The vertical dotted lines may indicate times at which the terminal transmits measurement prediction reports. The terminal may transmit two measurement prediction reports and perform two handovers through a measurement prediction-based proactive handover method proposed in the present disclosure in the same scenario as that according to the exemplary embodiments illustrated in FIG. 3. In other words, transmission of unnecessary measurement reports and execution of unnecessary handovers may be avoided. Times at which handovers are performed according to the exemplary embodiments illustrated in FIG. 4 may be t1 and t2. An RSRP indicated by X may represent an RSRP of a serving cell according to the exemplary embodiments illustrated in FIG. 3.

The terminal may obtain a signal strength (e.g. RSRP) 400 of a serving cell through measurement on the serving cell. The terminal may obtain an RSRP 410 of a first neighboring cell through measurement on the first neighboring cell. The terminal may compare the RSRP 400 of the serving cell and the RSRP 410 of the first neighboring cell. The terminal may determine whether a measurement prediction report event is satisfied based on a comparison result between the RSRP 400 of the serving cell and the RSRP 410 of the first neighboring cell. When the terminal determines that the measurement prediction report event is satisfied, the terminal may transmit a first measurement prediction report to the source base station. After receiving the first measurement prediction report, the source base station may determine the first neighboring cell as a target cell. The terminal may perform a handover to the first neighboring cell.

The terminal may obtain an RSRP 410 of a serving cell through measurement on the serving cell. The terminal may obtain an RSRP 430 of a third neighboring cell through measurement on the third neighboring cell. The terminal may compare the RSRP 410 of the serving cell and the RSRP 430 of the third neighboring cell. The terminal may determine whether a measurement prediction report event is satisfied based on a comparison result between the RSRP 410 of the serving cell and the RSRP 430 of the third neighboring cell. When the terminal determines that the measurement prediction report event is satisfied, the terminal may transmit a second measurement prediction report to the source base station. After receiving the second measurement prediction report, the source base station may determine the third neighboring cell as a target cell. The terminal may perform a handover to the third neighboring cell.

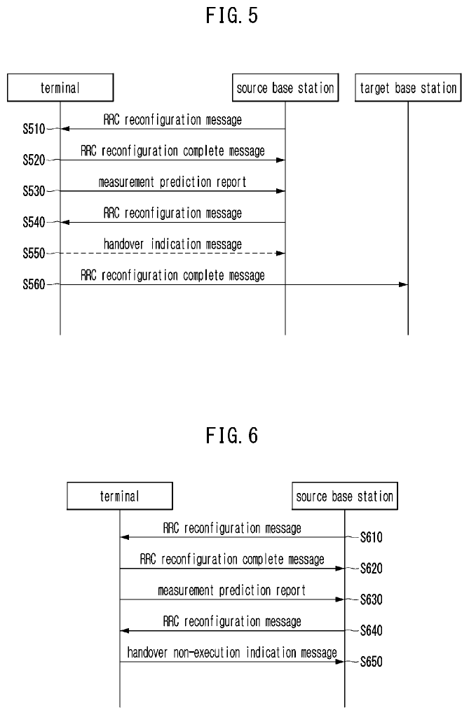

FIG. 5 is a sequence diagram illustrating exemplary embodiments of a measurement prediction-based handover procedure.

Referring to FIG. 5, a source base station may identify a terminal capable of performing measurement and measurement prediction on signal strengths (e.g. RSRP) of a serving cell and/or neighboring cells based on capability information of the terminal and/or a configuration of a network. The source base station may transmit measurement prediction configuration information to the terminal through an RRC reconfiguration message (S510). The terminal may receive the measurement prediction configuration information from the source base station after performing measurement based on measurement configuration information. Alternatively, the terminal may perform measurement after receiving measurement configuration information including the measurement prediction configuration information. The measurement prediction configuration information may include measurement prediction report configuration information.

After receiving the measurement prediction configuration information, the terminal may transmit an RRC reconfiguration complete message to the source base station (S520). After transmitting the RRC reconfiguration complete message, the terminal may perform measurement prediction on the source cell and/or neighboring cells according to the measurement prediction configuration information and may generate one or more measurement prediction reports including measurement prediction results. The terminal may transmit the one or more measurement prediction reports to the source base station periodically or when a measurement prediction report event is satisfied (S530). After receiving the one or more measurement prediction reports, the source base station may determine a target base station (or a target cell) based on the one or more measurement prediction reports. The source base station may transmit an RRC reconfiguration message including information required to access the target base station to the terminal (S540). After receiving the RRC reconfiguration message, the terminal may transmit a handover indication message to the source base station (or a source cell) (S550). The procedure of transmitting the handover indication message may be omitted. The terminal may transmit an RRC reconfiguration complete message to the target base station to complete the handover procedure (S560). The target base station may complete the handover procedure by receiving the RRC reconfiguration complete message from the terminal.

FIG. 6 is a sequence diagram illustrating exemplary embodiments of a measurement prediction-based handover procedure.

Referring to FIG. 6, a source base station may identify a terminal capable of performing measurement and measurement prediction on signal strengths (e.g. RSRP) of a serving cell and/or neighboring cells based on capability information of the terminal and/or a configuration of a network. The source base station may transmit measurement prediction configuration information to the terminal through an RRC reconfiguration message (S610). The measurement prediction configuration information may include measurement prediction report configuration information.

After receiving the measurement prediction configuration information, the terminal may transmit an RRC reconfiguration complete message to the source base station (S620). After transmitting the RRC reconfiguration complete message, the terminal may perform measurement prediction on the source cell and/or neighboring cells according to the measurement prediction configuration information and may generate one or more measurement prediction reports including measurement prediction results. The terminal may transmit the one or more measurement prediction reports to the source base station periodically or when a measurement prediction report event is satisfied (S630). After receiving the one or more measurement prediction reports, the source base station may determine a target base station (or a target cell) based on the one or more measurement prediction reports.

After determining the target base station (or the target cell), the source base station may transmit an RRC reconfiguration message including information required to access the target base station to the terminal (S640). Measurement results and/or measurement prediction results may change after the terminal transmits the RRC reconfiguration complete message. The terminal receiving the RRC reconfiguration message may determine whether to perform a handover to the target base station based on changes in the measurement results and/or the measurement prediction results. When the terminal determines not to perform the handover to the target base station, the terminal may transmit a handover non-execution indication message to the source base station (S650). By using the handover non-execution indication message, the terminal may inform the source base station that the terminal determines not to perform the handover to the target base station. The handover non-execution indication message may include the changed measurement results and/or changed measurement prediction results.

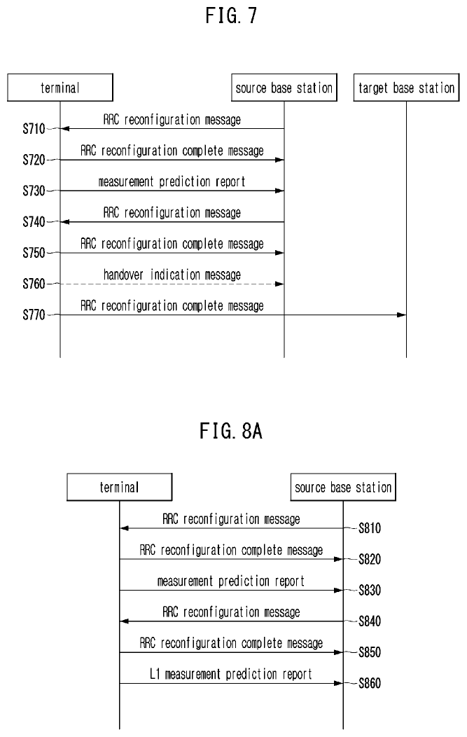

FIG. 7 is a sequence diagram illustrating exemplary embodiments of a measurement prediction-based handover procedure.

Referring to FIG. 7, a source base station may identify a terminal capable of performing measurement and measurement prediction on signal strengths (e.g. RSRP) of a serving cell and/or neighboring cells based on capability information of the terminal and/or a configuration of a network. The source base station may transmit measurement prediction configuration information to the terminal through an RRC reconfiguration message (S710). The measurement prediction configuration information may include measurement prediction report configuration information.

After receiving the measurement prediction configuration information, the terminal may transmit an RRC reconfiguration complete message to the source base station (S720). After transmitting the RRC reconfiguration complete message, the terminal may perform measurement prediction on the source cell and/or neighboring cells according to the measurement prediction configuration information and may generate one or more measurement prediction reports including measurement prediction results. The terminal may transmit the one or more measurement prediction reports to the source base station periodically or when a measurement prediction report event is satisfied (S730).

After receiving the one or more measurement prediction reports, the source base station may determine conditional handover (CHO) candidate target base stations (or target cells) based on the one or more measurement prediction reports. The source base station may transmit an RRC reconfiguration message including information required to access the CHO candidate target base stations and/or identification information thereof to the terminal (S740). The above-described RRC reconfiguration message may include a conditional handover execution condition that should be satisfied to determine whether to execute the conditional handover.

After receiving the RRC reconfiguration message, the terminal may transmit an RRC reconfiguration complete message to the source base station (or the source cell) (S750). The terminal may determine a CHO target base station among the CHO candidate target base stations for which the conditional handover execution condition is satisfied. When the terminal determines that the conditional handover execution condition is satisfied, the terminal may determine to execute a handover to the CHO target base station for which the conditional handover execution condition is satisfied. After determining to execute the handover, the terminal may transmit a handover indication message to the source base station (S760). The handover indication message may include information indicating at least one of that the terminal executes the conditional handover or which CHO candidate target base station is selected by the terminal from among the CHO candidate target base stations for execution of the conditional handover. The procedure of transmitting the handover indication message may be omitted. The terminal may transmit an RRC reconfiguration complete message to the CHO target base station to complete the handover procedure (S770). The CHO target base station may complete the handover procedure by receiving the RRC reconfiguration complete message from the terminal.

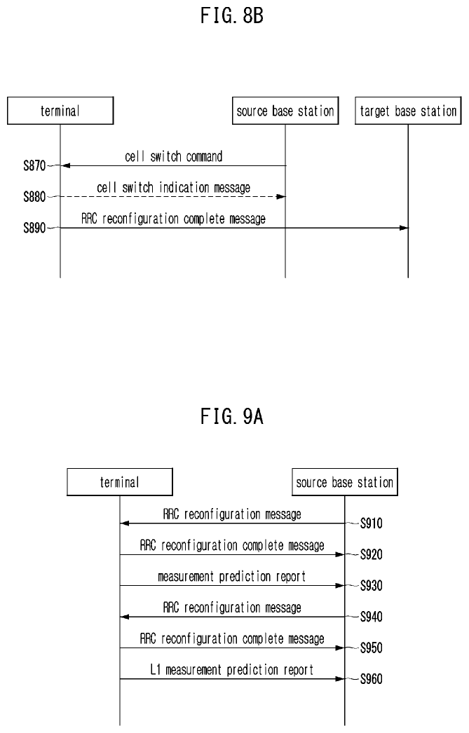

FIG. 8A and FIG. 8B are sequence diagrams illustrating exemplary embodiments of a measurement prediction-based handover procedure.

Referring to FIG. 8A, a source base station may identify a terminal capable of performing measurement and measurement prediction on signal strengths (e.g. RSRP) of a serving cell and/or neighboring cells based on capability information of the terminal and/or a configuration of a network. The source base station may transmit measurement prediction configuration information to the terminal through an RRC reconfiguration message (S810). The measurement prediction configuration information may include measurement prediction report configuration information.

After receiving the measurement prediction configuration information, the terminal may transmit an RRC reconfiguration complete message to the source base station (S820). After transmitting the RRC reconfiguration complete message, the terminal may perform measurement prediction on the source cell and/or neighboring cells according to the measurement prediction configuration information and may generate one or more measurement prediction reports including measurement prediction results. The terminal may transmit the one or more measurement prediction reports to the source base station periodically or when a measurement prediction report event is satisfied (S830).

After receiving the one or more measurement prediction reports, the source base station may determine lower layer triggered mobility (LTM) candidate target base stations (or target cells) based on the one or more measurement prediction reports. The source base station may transmit LTM configuration information including information required to access the LTM candidate target base stations and/or identification information thereof to the terminal through an RRC reconfiguration message (S840). The above-described RRC reconfiguration message may include L1 measurement prediction report configuration information for an L1 measurement prediction report of the terminal. Alternatively, the LTM configuration information may include the L1 measurement prediction report configuration information. The L1 measurement prediction report may be required to perform an LTM procedure.

After receiving the RRC reconfiguration message, the terminal may transmit an RRC reconfiguration complete message to the source base station (or the source cell) (S850). After transmitting the RRC reconfiguration complete message, the terminal may transmit one or more L1 measurement prediction reports including L1 measurement prediction results (e.g. RSRP values for the LTM candidate cells) to the source base station (S860). After receiving the one or more L1 measurement prediction reports, the source base station may determine an LTM target cell among the LTM candidate cells based on the one or more L1 measurement prediction reports.

Referring to FIG. 8B, after determining the LTM target cell, the source base station may transmit a cell switch command including information required to access the LTM target cell to the terminal (S870). After receiving the cell switch command, the terminal may transmit a cell switch indication message to the source base station to inform the source base station that LTM is executed (S880). The terminal may transmit an RRC reconfiguration complete message to the LTM target base station to complete the handover procedure (S890). The LTM target base station may complete the handover procedure by receiving the RRC reconfiguration complete message from the terminal.

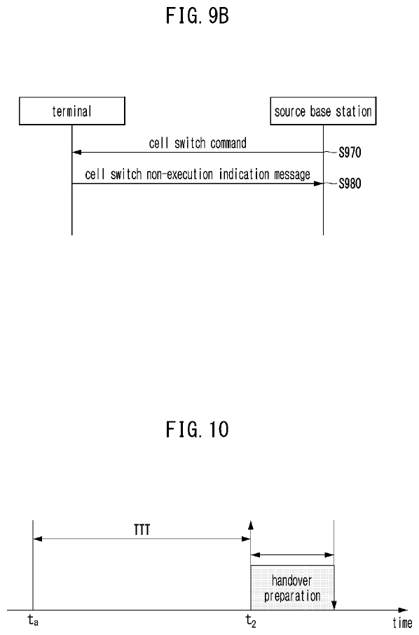

FIG. 9A and FIG. 9B are sequence diagrams illustrating exemplary embodiments of a measurement prediction-based handover procedure.

Referring to FIG. 9A, a source base station may identify a terminal capable of performing measurement and measurement prediction on signal strengths (e.g. RSRP) of a serving cell and/or neighboring cells based on capability information of the terminal and/or a configuration of a network. The source base station may transmit measurement prediction configuration information to the terminal through an RRC reconfiguration message (S910). The measurement prediction configuration information may include measurement prediction report configuration information.

After receiving the measurement prediction configuration information, the terminal may transmit an RRC reconfiguration complete message to the source base station (S920). After transmitting the RRC reconfiguration complete message, the terminal may perform measurement prediction on the source cell and/or neighboring cells according to the measurement prediction configuration information and may generate one or more measurement prediction reports including measurement prediction results. The terminal may transmit the one or more measurement prediction reports to the source base station periodically or when a measurement prediction report event is satisfied (S930).

After receiving the one or more measurement prediction reports, the source base station may determine LTM candidate target base stations (or target cells) based on the one or more measurement prediction reports. The source base station may transmit LTM configuration information including information required to access the LTM candidate target base stations and/or identification information thereof to the terminal through an RRC reconfiguration message (S940). The above-described RRC reconfiguration message may include L1 measurement prediction report configuration information for an L1 measurement prediction report of the terminal. Alternatively, the LTM configuration information may include the L1 measurement prediction report configuration information. The L1 measurement prediction report may be required to perform an LTM procedure.

After receiving the RRC reconfiguration message, the terminal may transmit an RRC reconfiguration complete message to the source base station (or the source cell) (S950). After transmitting the RRC reconfiguration complete message, the terminal may transmit one or more L1 measurement prediction reports including L1 measurement prediction results to the source base station (S960). After receiving the one or more L1 measurement prediction reports, the source base station may determine an LTM target cell among the LTM candidate cells based on the one or more L1 measurement prediction reports.

Referring to FIG. 9B, after determining the LTM target cell, the source base station may transmit a cell switch command including information required to access the target cell to the terminal (S970). L1 measurement results and/or L1 measurement prediction results may change after the terminal transmits the one or more L1 measurement prediction reports. Due to changes in the L1 measurement results and/or the L1 measurement prediction results, the terminal receiving the cell switch command may determine whether to perform LTM for the target cell determined by the source base station. When the terminal determines not to perform LTM, the terminal may transmit a cell switch non-execution indication message to the source base station (S980). By using the cell switch non-execution indication message, the terminal may inform the source base station that the terminal does not perform LTM. The cell switch non-execution indication message may include the changed L1 measurement results and/or changed L1 measurement prediction results.

The measurement prediction-based handover procedures according to the exemplary embodiments illustrated in FIG. 5 and FIG. 6 may be applied not only to a primary node change procedure but also to a secondary node change procedure. The proactive conditional handover procedure according to the exemplary embodiments illustrated in FIG. 7 may be applied to procedures for addition and change of a secondary node. The LTM procedures according to the exemplary embodiments illustrated in FIG. 8A to FIG. 9B may be applied to an LTM secondary node change procedure.

A description of a conventional measurement report event is provided below. An A3 event may be satisfied when a state in which a signal strength (e.g. RSRP, RSRQ, or SINR) of a specific neighboring cell is higher than that of a serving cell by at least an offset (e.g. an HO margin) (hereinafter referred to as an ‘A3 event trigger condition’) is maintained during TTT. A description of the A3 event will be provided under an assumption that L3 measurements according to an L3 measurement periodicity are performed four times during TTT. When the A3 event trigger conditions according to first, second, and fourth L3 measurement results are satisfied and the A3 event trigger condition according to a third L3 measurement result is not satisfied, the A3 event may not be satisfied. However, after the A3 event trigger condition according to the above-described fourth L3 measurement result is satisfied, if the A3 event trigger conditions according to three consecutive L3 measurement results are satisfied, a measurement report may be transmitted when the A3 event is satisfied. According to the above-described measurement report procedure, a time at which handover is completed may be delayed, and thus a problem in which a user-perceived data rate is degraded may occur.

A description of an event trigger condition for triggering a measurement report event is provided below. The measurement report configuration information included in measurement configuration information may include measurement report event configuration information. The measurement report event configuration information may include at least one of a measurement report event identifier, an entering condition and/or a leaving condition, hysteresis, or TTT corresponding to a measurement report event, or a list of cells associated with occurrence of the measurement report event. The terminal may be configured by the measurement report configuration information such that a measurement report is transmitted when two or more events are simultaneously satisfied. The measurement report may include at least one of identification information on one or more cells satisfying an event, measurement results (e.g. RSRP, RSRQ, and/or SINR) for the one or more cells, measurement results for serving cells, measurement results for a cell having the best measurement result, or measurement results for top k cells based on measurement results. k is a natural number and may be set by the measurement report configuration information or may be a preconfigured value.

Whether an A3 event trigger condition is satisfied may be determined based on whether an entering condition and a leaving condition are satisfied. Maintaining the A3 event trigger condition during TTT may be equivalent to the leaving condition not being satisfied during TTT after a time at which the entering condition is satisfied. Alternatively, when a relaxation condition and a relaxation time are configured, maintaining the A3 event trigger condition during TTT may be equivalent to a state in which the relaxation condition is satisfied not exceeding the relaxation time during TTT after a time at which the entering condition is satisfied. The entering and leaving conditions corresponding to the A3 event may be as shown in Equation 1 and Equation 2 below.

$$Mn + Ofn + Ocn - Hys > Mp + Ofp + Ocp + Off \qquad [ Equation 1 ]$$

$$Mn + Ofn + Ocn + Hys < Mp + Ofp + Ocp + Off \qquad [ Equation 2 ]$$

A description of parameters described in Equation 1 and Equation 2 is provided below. Mn may be a measurement result for a neighboring cell to which an offset is not applied. Ofn may be an offset per measurement object corresponding to a reference signal of the neighboring cell. Ocn may be a cell-specific offset for the neighboring cell. Mp may be a measurement result for a serving cell (e.g. a secondary primary cell) to which an offset is not applied. Ofp may be an offset per measurement object for the serving cell. Ocp may be a cell-specific offset for the serving cell. Hys may be a hysteresis parameter for the A3 event. Off may be an offset parameter for the A3 event. Off may be set as an a3-offset included in measurement report configuration information. Units of Mn and Mp may be dBm when signal strength is measured as RSRP, and may be dB when signal strength is measured as RSRQ or SINR. Ofn, Ocn, Ofp, Ocp, Hys, and Off may all be expressed in units of dB. The A3 event is only an example among measurement report events, and other measurement events may be used for triggering a measurement report in the present disclosure.

A description of an A7 event is provided below. An entering condition corresponding to the A7 event may be that a specific neighboring cell is a cell having the best signal strength among cells whose signal strengths are measured. A leaving condition corresponding to the A7 event may be that a specific neighboring cell is not a cell having the best signal strength among cells whose signal strengths are measured. In another example, an entering condition corresponding to the A7 event may be that a specific neighboring cell is within the top x neighboring cells based on signal strength among cells whose signal strengths are measured. A leaving condition corresponding to the A7 event may be that a specific neighboring cell is not within the top y neighboring cells based on signal strength among cells whose signal strengths are measured. x or y may be a natural number and may be set by the measurement report configuration information or may be a preconfigured value.

The measurement report configuration information may include relaxation condition configuration information and/or relaxation time configuration information. A relaxation condition may be that a specific cell becomes a cell within the top x cells based on signal strength among cells whose signal strengths are measured. In another example, the measurement report configuration information may configure at least one of a relaxation condition, a measurement periodicity, or a measurement prediction periodicity for the A7 event to the terminal. A relaxation condition may be that a specific cell is within the top x cells based on signal strength among cells whose signal strengths are measured. The number of times measurement or measurement prediction is performed within a preconfigured time may be determined based on the measurement periodicity or the measurement prediction periodicity.

Table 1 below may be a table for describing an entering condition, a leaving condition, a relaxation condition, TTT, and a relaxation time corresponding to the A7 event. A unit of time may be msec. As a result of performing measurement on neighboring cells (e.g. a first cell, a second cell, a third cell, a fourth cell, and a fifth cell), a ranking per cell in descending order of RSRP may be identified in Table 1. In Table 1, TTT may be 120 msec, a relaxation condition may be that a specific cell is within the top 2 cells based on RSRP among measured cells, and a relaxation time may be 40 msec. An entering condition may be that a specific cell is within top 2 cells based on RSRP among measured cells, and a leaving condition may be that a specific cell is ranked third or lower based on RSRP among measured cells.

Referring to Table 1, at 0 msec, rankings of all cases may be ranked first, and all cases may satisfy the entering condition. At 40 msec, rankings of all cases may be ranked second, and all cases may satisfy the relaxation condition. At 80 msec, rankings of all cases may be ranked third, and all cases may satisfy the leaving condition. At 120 msec, rankings of all cases may be ranked first, and all cases may satisfy the entering condition. At 160 msec, rankings of all cases may be within the top two, and all cases may satisfy the relaxation condition. At 200 msec, a ranking of a second case may be ranked second, and the second case may satisfy the relaxation condition. At 240 msec, a first case to a fourth case may satisfy an event trigger condition during TTT (e.g. 120 msec) and thus may satisfy the A7 event. At 240 msec, a fifth case may satisfy the relaxation condition. However, at 240 msec, the fifth case may satisfy the leaving condition because the relaxation time has already been exhausted based on a time of 120 msec at which the entering condition is satisfied. At 320 msec, a ranking of the fifth case may be ranked first. At 320 msec, the fifth case may satisfy the A7 event by satisfying the A7 event trigger condition during TTT (e.g. 120 msec) based on a time 200 msec at which the entering condition is satisfied.

TABLE 1

| Time | 0 | 40 | 80 | 120 | 160 | 200 | 240 | 280 | 320 |
|---|---|---|---|---|---|---|---|---|---|
| First case | 1 | 2 | 3 | 1 | 1 | 1 | 1 | — | — |
| Second case | 1 | 2 | 3 | 1 | 1 | 2 | 1 | — | — |
| Third case | 1 | 2 | 3 | 1 | 2 | 1 | 1 | — | — |
| Fourth case | 1 | 2 | 3 | 1 | 1 | 1 | 2 | — | — |
| Fifth case | 1 | 2 | 3 | 1 | 2 | 1 | 2 | 2 | 1 |

In another example, an A8 event may be configured as an event for triggering a measurement report. An entering condition corresponding to the A8 event may be that a ranking of a specific neighboring cell among neighboring cells whose signal strengths are measured is within the top k based on signal strength. A leaving condition corresponding to the A8 event may be that a ranking of a specific neighboring cell among neighboring cells whose signal strengths are measured is not within the top k based on signal strength. k may be a natural number and may be set by the measurement report configuration information or may be a preconfigured value.

In another example, an A9 event may be configured as an event for triggering a measurement report. An entering condition corresponding to the A9 event may be that a serving cell is not a cell having the best signal strength among cells whose signal strengths are measured. A leaving condition corresponding to the A9 event may be that a serving cell is not a cell having the best signal strength among cells whose signal strengths are measured.

The measurement report events described above (e.g. A7 event, A8 event, or A9 event) and the entering conditions, leaving conditions, relaxation conditions, TTT, and relaxation time corresponding to the events may be equally applied to an L1 measurement report procedure.

A measurement report based on an event window is described below. An event window may be configured to determine whether a measurement report event is satisfied. The event window may be a time interval. The event window may be configured by measurement report configuration information. When the event window is a time interval, the event window may include a start time (hereinafter referred to as an ‘event window start time’) and an end time (hereinafter referred to as an ‘event window end time’) for determining whether the measurement report event is satisfied.

An event window start time may be the most recent time at which a measurement report event is satisfied. An event window end time may be a time after a preconfigured time elapses from the event window start time. For example, when the size of the event window configured by measurement report configuration information is 320 msec and the most recent time at which a measurement report event is satisfied is Tf, the event window may be defined as [Tf, Tf+320 msec]. In another example, an event window end time may be a most recent time at which measurement is performed, and an event window start time may be a time before the event window end time by a preconfigured time. For example, when a size of the preconfigured event window is 320 msec and the most recent time at which measurement is performed is Tl, the event window may be defined as [Tl-320 msec, Tl].

In another example, an event window may correspond to a number of repetitions of a measurement period (hereinafter referred to as a ‘measurement period count’). The event window may be configured by the measurement report configuration information. When the event window is the measurement period count, the event window may include a measurement start time (hereinafter referred to as an ‘event window measurement start time’) and a measurement end time (hereinafter referred to as an ‘event window measurement end time’) for determining whether a measurement report event is satisfied.

An event window measurement start time may be the most recent time at which a measurement report event is satisfied, and an event window measurement end time may be a time after a preconfigured number of measurement periods from the event window measurement start time. For example, when the size of the preconfigured event window is 4 and the most recent time at which the measurement report event is satisfied is Mf, the event window may be defined as [Mf, Mf+4]. In another example, an event window measurement end time may be a most recent time at which measurement is performed, and an event window measurement start time may be a time before the event window measurement end time by a preconfigured size of the event window (e.g. measurement period count). For example, when a size of the preconfigured event window is 4 and the most recent time at which measurement is performed is Ml, the event window may be defined as [Ml-4, MI].

When an event window is a time interval, if a duration during which a specific condition (hereinafter referred to as an ‘event condition’) is satisfied is equal to or greater than a threshold within the event window, a measurement report event may be determined to be satisfied. For example, when the size of the event window is 320 msec and the threshold is set to 240 msec, if a duration during which an event condition is satisfied within the event window is equal to or greater than 240 msec, a measurement report event may be determined to be satisfied. Alternatively, when a ratio of a duration during which an event condition is satisfied within the event window is equal to or greater than a threshold, a measurement report event may be determined to be satisfied. For example, when the size of the event window is 320 msec and a threshold ratio is set to 75%, if a duration during which an event condition is satisfied within the event window is equal to or greater than 75%, a measurement report event may be determined to be satisfied.

In another example, an event window may be configured as a measurement period count. When a number of times an event condition is satisfied among measurement results performed according to a measurement periodicity within the event window is equal to or greater than a threshold, a measurement report event may be determined to be satisfied. For example, the size of the event window may be set to 4 and the threshold may be set to 3. That is, four measurements may be performed within the event window according to the measurement periodicity. When the event condition is satisfied three or more times within the event window, the measurement report event may be determined to be satisfied. In another example, the size of the event window may be set to 4 and the threshold ratio may be set to 75%. When a ratio of times the event condition is satisfied within the event window is equal to or greater than 75%, the measurement report event may be determined to be satisfied.

The above-described event window may be used not for determining whether a measurement report event is satisfied, but for determining whether an entering condition and/or a leaving condition corresponding to the measurement report event are satisfied. For example, when a duration during which the event condition is satisfied within the event window is equal to or greater than a threshold (or exceeds the threshold), the entering condition may be determined to be satisfied. When the duration during which the event condition is satisfied within the event window is less than the threshold (or equal to or less than the threshold), the leaving condition may be determined to be satisfied. In another example, when the number of times the event condition is satisfied among measurement results performed according to the measurement periodicity within the event window is equal to or greater than a threshold (or exceeds the threshold), the entering condition may be determined to be satisfied. When a number of times that the event condition is satisfied among measurement results performed according to the measurement periodicity within the event window is less than the threshold (or equal to or less than the threshold), the leaving condition may be determined to be satisfied. When a relaxation time and/or a relaxation condition is configured by the measurement report configuration information, the relaxation time and/or the relaxation condition may be used for determining whether the measurement report event based on the event window is satisfied or for determining whether the entering condition and/or the leaving condition based on the event window is satisfied. Determining whether the measurement report event based on the event window is satisfied or determining whether the entering condition and/or the leaving condition based on the event window is satisfied may be applied to an L1 measurement report procedure or an L1 measurement prediction report procedure.

A measurement prediction report based on an event window is described below. An event window may be configured to determine whether a measurement prediction report event is satisfied. The event window may be a time interval. The event window may be configured by the measurement prediction report configuration information. When the event window is a time interval, the event window may be configured with a start time (hereinafter referred to as an ‘event window start time’) and an end time (hereinafter referred to as an ‘event window end time’) for determining whether the measurement prediction report event is satisfied.

An event window start time may be the most recent time at which a measurement prediction report event is satisfied. An event window end time may be a time after a preconfigured time from the event window start time. For example, when the size of the event window configured by measurement prediction report configuration information is 320 msec and the most recent time at which the measurement prediction report event is satisfied is Tf, the event window may be defined as [Tf, Tf+320 msec]. In another example, an event window end time may be the most recent time at which measurement is performed, and an event window start time may be a time before the event window end time by a preconfigured time. For example, when the size of the preconfigured event window is 320 msec and the most recent time at which measurement prediction is performed is Tl, the event window may be defined as [Tl-320 msec, Tl].

In another example, an event window may correspond to a number of repetitions of a measurement prediction period (hereinafter referred to as a ‘measurement prediction period count’). The event window may be configured by the measurement prediction report configuration information. When the event window is defined by the measurement prediction period count, the event window may be configured with a measurement start time (hereinafter referred to as an ‘event window measurement start time’) and a measurement end time (hereinafter referred to as an ‘event window measurement end time’) for determining whether a measurement prediction report event is satisfied.

An event window measurement start time may be the most recent time at which a measurement prediction report event is satisfied, and an event window measurement end time may be a time after a preconfigured number of measurement prediction periods from the event window measurement start time. For example, when the size of the preconfigured event window is 4 and the most recent time at which the measurement prediction report event is satisfied is Mf, the event window may be defined as [Mf, Mf+4]. In another example, an event window measurement end time may be the most recent time at which measurement prediction is performed, and an event window measurement start time may be a time before the event window measurement end time by a preconfigured size of the event window (e.g. measurement prediction period count). For example, when the size of the preconfigured event window is 4 and the most recent time at which measurement prediction is performed is Ml, the event window may be defined as [Ml-4, Ml].

When an event window is a time interval, if a duration during which an event condition is satisfied within the event window is equal to or greater than a threshold, a measurement prediction report event may be determined to be satisfied. For example, when the size of the event window is 320 msec and the threshold is set to 240 msec, if the duration during which the event condition is satisfied within the event window is equal to or greater than 240 msec, the measurement prediction report event may be determined to be satisfied. Alternatively, when a ratio of the duration during which the event condition is satisfied within the event window is equal to or greater than a threshold, the measurement prediction report event may be determined to be satisfied. For example, when the size of the event window is 320 msec and the threshold ratio is set to 75%, if the duration during which the event condition is satisfied within the event window is equal to or greater than 75%, the measurement prediction report event may be determined to be satisfied.

In another example, an event window may be configured by a measurement prediction period count. When a number of times an event condition is satisfied among measurement prediction results performed according to a measurement prediction periodicity within the event window is equal to or greater than a threshold, a measurement prediction report event may be determined to be satisfied. For example, the size of the event window may be set to 4 and the threshold may be set to 3. That is, four measurement predictions may be performed within the event window according to the measurement prediction periodicity. When the event condition is satisfied three or more times within the event window, the measurement prediction report event may be determined to be satisfied. In another example, the size of the event window may be set to 4 and a threshold ratio may be set to 75%. When a ratio of the number of times the event condition is satisfied within the event window is equal to or greater than 75%, the measurement prediction report event may be determined to be satisfied.

The above-described event window may be used not for determining whether the measurement prediction report event is satisfied, but for determining whether an entering condition and/or a leaving condition corresponding to the measurement prediction report event are satisfied. For example, when a duration during which the event condition is satisfied within the event window is equal to or greater than a threshold (or exceeds the threshold), the entering condition may be determined to be satisfied. When a duration during which the event condition is satisfied within the event window is less than the threshold (or equal to or less than the threshold), the leaving condition may be determined to be satisfied. In another example, when the number of times the event condition is satisfied based on measurement prediction results obtained according to the measurement prediction periodicity within the event window is equal to or greater than a threshold (or exceeds the threshold), an entering condition may be determined to be satisfied. When the number of times the event condition is satisfied within the event window is less than the threshold (or equal to or less than the threshold), the leaving condition may be determined to be satisfied.

When a relaxation time and/or a relaxation condition is configured by the measurement prediction report configuration information, the relaxation time and/or the relaxation condition may be used for determining whether a measurement prediction report event based on the event window is satisfied or for determining whether an entering condition and/or a leaving condition based on the event window are satisfied. Determining whether the measurement prediction event based on the event window is satisfied or determining whether the entering condition and/or the leaving condition based on the event window is satisfied may be applied to an L1 measurement report procedure or an L1 measurement prediction report procedure. As a message used for the measurement prediction report (hereinafter referred to as a ‘measurement prediction report message’), a message for transmission of an existing measurement report (hereinafter referred to as a ‘measurement report message’) may be used. The measurement prediction report message using a structure of the existing measurement report message may include a flag indicating that the reported value is a measurement prediction result rather than a measurement result.

Examples of configuration of an event window is described below. The size of the event window may be set to 1 sec, and a threshold may be set to 750 msec. In another example, the size of the event window may be set to 1 sec, and a threshold ratio may be set to 75%. In another example, an event window may be configured by a measurement prediction period count rather than a time interval. The size of the event window may be set to 10, the measurement prediction periodicity may be set to 100 msec, and the threshold may be set to 7. In another example, the event window may be configured by a measurement prediction period count rather than a time interval. The size of the event window may be set to 10, the measurement prediction periodicity may be set to 100 msec, and the threshold ratio may be set to 75%. In another example, the event window may be configured by a measurement prediction period count rather than a time interval. A relaxation condition may be that a specific cell is within the top 2 cells based on signal strength among cells whose signal strengths are measured, a number of measurement prediction periods during which satisfaction of the relaxation condition is allowed (hereinafter referred to as a ‘relaxation measurement prediction period count’) may be set to 3, and the threshold ratio may be set to 100%. At all measurement prediction times located within the event window according to the measurement prediction periodicity, if a specific cell is within the top 2 cells based on signal strength among cells whose signal strengths are predicted and the number of times the specific cell is within the top 2 cells is equal to or less than 3, the measurement prediction report event may be determined to be satisfied.

The above-described measurement report event, measurement prediction report event, entering condition and/or leaving condition corresponding to the measurement report event and/or the measurement prediction report event, relaxation condition, relaxation time, determination of whether the measurement report event and/or the measurement prediction report event is satisfied based on the event window, and determination of whether the entering condition and/or the leaving condition is satisfied based on the event window may be applied to the measurement report or measurement prediction report procedures according to exemplary embodiments illustrated in FIG. 5 to FIG. 9B.

FIG. 10 is a timing diagram illustrating exemplary embodiments of a measurement report procedure.

Referring to FIG. 10, a timing diagram of a measurement report procedure for performing a conventional handover procedure may be identified. A terminal may perform measurement on a serving cell and/or neighboring cells. The terminal may identify whether a specific neighboring cell satisfies an A3 entering condition through measurement. The terminal may identify that the A3 entering condition is satisfied at a time tₐ. After identifying that the A3 entering condition is satisfied, the terminal may check whether a state in which the A3 entering condition is satisfied is maintained during TTT. After confirming that the state in which the A3 entering condition is satisfied is maintained during TTT, the terminal may transmit a measurement report including one or more measurement results to a base station (e.g. a source base station or a source cell) at a time t₂ after TTT elapses from tₐ.

After receiving the measurement report, the base station may determine a target cell (or a target base station) based on the measurement report. After determining the target cell, the base station may perform a handover preparation procedure for handover to the target cell. After performing the handover preparation procedure, the base station may transmit a handover command to the terminal.

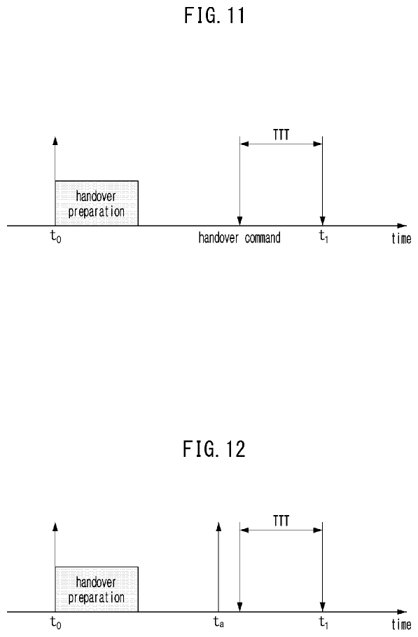

FIG. 11 is a timing diagram illustrating exemplary embodiments of a measurement prediction-based handover procedure.

Referring to FIG. 11, a timing diagram of a measurement prediction report procedure for performing a measurement prediction-based handover procedure may be identified. A terminal may perform measurement prediction at a time t₀. The terminal may predict that an A3 event is satisfied at a time t₁ through measurement prediction. The prediction of whether the A3 event is satisfied and the prediction of a time at which the A3 event is satisfied may be referred to as A3 event prediction. After predicting that the A3 event is satisfied, the terminal may transmit a measurement prediction report including one or more measurement prediction results to a base station (e.g. a source base station or a source cell) at the time t₀. To transmit the measurement prediction report, the terminal may use a message for an existing measurement report. To transmit the measurement prediction report, the terminal may include, in the measurement prediction report, a flag indicating that the values included in the message are measurement prediction results.

After receiving the measurement prediction report, the base station may determine a target cell (or a target base station) based on the measurement prediction report. After determining the target cell, the base station may perform a handover preparation procedure for handover to the target cell. The base station completing the handover preparation procedure may transmit a handover command to the terminal. However, if the handover command is transmitted at an excessively early time, handover reliability may be degraded. Accordingly, the base station may transmit the handover command to the terminal at a time prior to TTT from the time (e.g. t₁) predicted by the terminal for satisfaction of the A3 event.

Improving handover reliability only with the A3 event prediction result may have limitations. When not only the A3 event prediction result by the terminal but also actual measurement results by the terminal are used, handover reliability may be improved. In the following, handover reliability improvement procedures using actual measurement results by the terminal will be described in exemplary embodiments illustrated in FIG. 12 to FIG. 15.

FIG. 12 is a timing diagram illustrating exemplary embodiments of a measurement prediction-based handover reliability improvement procedure.

Referring to FIG. 12, a terminal may perform measurement prediction on a serving cell and/or neighboring cells. The terminal may predict that a specific neighboring cell satisfies an A3 event at a time t₁ through measurement prediction. A3 event prediction by the terminal may be performed at a time t₀. After performing the A3 event prediction, the terminal may transmit a measurement prediction report to a base station (e.g. a source base station or a source cell) at the time t₀. To transmit the measurement prediction report, the terminal may use a message for an existing measurement report. To transmit the measurement prediction report, the terminal may include, in the measurement prediction report, a flag indicating that the values included in the message are measurement prediction results.

After receiving the measurement prediction report, the base station may determine a target cell (or a target base station). After determining the target cell, the base station may perform a handover preparation procedure for handover to the target cell. The terminal may perform measurement on a source cell and/or neighboring cells. The terminal may identify whether a specific neighboring cell satisfies an A3 event entering condition based on measurement. The terminal may identify that the A3 event entering condition is satisfied at a time tₐ. The time tₐ may not be the same as a time prior to TTT from t₁. The time tₐ may be earlier than a time that is TTT earlier than t₁. Alternatively, the time tₐ may be later than a time that is TTT earlier than t₁. After identifying that the A3 event entering condition is satisfied, the terminal may transmit a measurement report including one or more measurement results to the base station. After receiving the measurement report, the base station may transmit a prepared handover command to the terminal.

To perform the above-described procedures, the base station may configure the terminal, through configuration information (e.g. measurement prediction configuration information), to transmit a measurement report when a specific condition is satisfied after transmitting the measurement prediction report. The terminal receiving the configuration information including the specific condition may transmit the measurement report when the specific condition is satisfied after transmitting the measurement prediction report. Alternatively, the terminal may transmit the measurement report when a preconfigured condition is satisfied after transmitting the measurement prediction report. For example, a condition that one or more measurement results satisfy the A3 event entering condition may be included in the measurement prediction configuration information as reportOnEnteringConditionsByActualMeasurementResults.

In another example, the base station may transmit configuration information (e.g. measurement prediction configuration information) so that the terminal transmits a measurement report including one or more measurement results at a time before TTT from the time t₁ after transmitting the measurement prediction report. After receiving the configuration information, the terminal may transmit the measurement report to the base station at a time prior to TTT from t₁. After receiving the measurement report, the base station may determine whether to perform a handover based on the measurement report. When the base station determines to perform the handover, the base station may determine a target cell. After determining the target cell, the base station may transmit a prepared handover command to the terminal. Alternatively, when the base station determines not to perform the handover, the base station may not transmit the prepared handover command to the terminal.

When a handover is performed based on actual measurement results and measurement prediction results by the terminal, it may be ensured that a signal strength (e.g. RSRP, RSRQ, SINR, or SNR) of a target cell is higher than that of a serving cell by an A3 offset. When it is ensured that the signal strength of the target cell is higher than the signal strength of the serving cell by the A3 offset, handover reliability may be improved.

However, according to the above-described procedures, the base station may receive at least two measurement reports or measurement prediction reports from the terminal. The reception of at least two measurement reports or measurement prediction reports may result in waste of radio resources or increased battery consumption of the terminal. A method for improving handover reliability by performing measurement prediction (e.g. A3 event prediction) at a time when the probability of handover is high is described below.

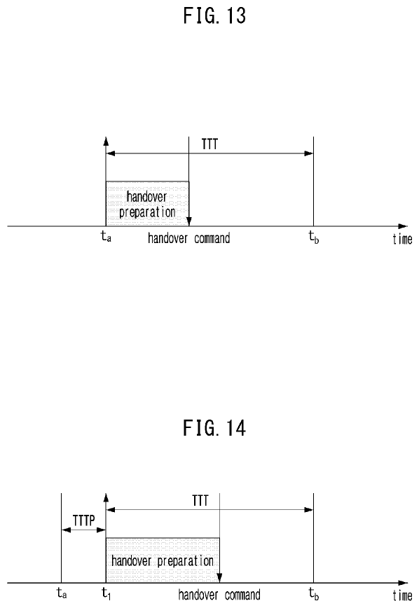

FIG. 13 is a timing diagram illustrating exemplary embodiments of a measurement prediction-based handover reliability improvement procedure.

Referring to FIG. 13, a terminal may perform measurement on a serving cell and neighboring cells based on measurement configuration information received from a base station. The terminal may identify whether a specific neighboring cell satisfies an A3 event entering condition based on one or more measurement results obtained through measurement. The terminal may identify that an A3 event entering condition is satisfied at a time tₐ. The terminal may receive the measurement prediction configuration information from the base station after performing measurement based on the measurement configuration information. Alternatively, the terminal may perform measurement after receiving the measurement configuration information including the measurement prediction configuration information. After identifying that the A3 event entering condition is satisfied, the terminal may predict that the A3 event is satisfied at a time tp. In other words, the terminal may configure a specific condition included in the measurement prediction configuration information. The terminal may determine whether the specific condition is satisfied. The terminal may perform measurement prediction when the specific condition is satisfied. The A3 event prediction may be performed at the time tₐ.

After predicting satisfaction of the A3 event, the terminal may transmit a measurement prediction report including one or more measurement prediction results and/or one or more measurement results to the base station. In other words, the terminal may determine whether the measurement prediction report is required based on the measurement prediction results according to measurement prediction event configuration information. The terminal may transmit measurement prediction reports including the measurement prediction results to the base station based on whether the measurement prediction report is required. The measurement prediction event configuration information may be included in the measurement configuration information or the measurement prediction configuration information and may be received by the terminal. Alternatively, the measurement prediction event configuration information may be received independently of the measurement configuration information and the measurement prediction configuration information.

A transmission time of the measurement prediction report may be different from the time tₐ. To transmit the measurement prediction report, the terminal may use a message for an existing measurement report. To transmit the measurement prediction report, the terminal may include, in the measurement prediction report, a flag indicating that the values included in the message are measurement prediction results.

After receiving the measurement prediction report, the base station may determine a target cell (or a target base station) based on the measurement prediction report. After determining the target cell, the base station may perform handover preparation for handover to the target cell. The base station completing the handover preparation may transmit a handover command to the terminal.

To perform the above-described procedures, the base station may transmit configuration information (e.g. measurement prediction configuration information) so that the terminal performs measurement prediction (e.g. A3 event prediction) when a specific condition is satisfied. Alternatively, the terminal may perform measurement prediction when a preconfigured condition is satisfied. For example, a condition that one or more measurement results satisfy an A3 event entering condition may be included in the measurement prediction configuration information as reportOnEnteringConditionsByActualMeasurementResults.

When a handover is performed based on actual measurement results and measurement prediction results by the terminal, it may be ensured that a signal strength (e.g. RSRP, RSRQ, SINR, or SNR) of a target cell is higher than a signal strength of a serving cell by an A3 offset. When it is ensured that the signal strength of the target cell is higher than the signal strength of the serving cell by the A3 offset, handover reliability may be improved. In addition, since the base station receives one measurement prediction report from the terminal, battery consumption of the terminal and waste of radio resources may be avoided.

FIG. 14 is a timing diagram illustrating exemplary embodiments of a measurement prediction-based handover reliability improvement procedure.

Referring to FIG. 14, a terminal may perform measurement on a serving cell and/or neighboring cells. The terminal may identify whether a specific neighboring cell satisfies an A3 event entering condition based on one or more measurement results. The terminal identifying that the A3 event entering condition is satisfied at a time tₐ may predict that the A3 event is satisfied at a time tp. In other words, the terminal may configure a specific condition included in measurement prediction configuration information. The terminal may determine whether the specific condition is satisfied. The terminal may perform measurement prediction when the specific condition is satisfied.

After predicting satisfaction of the A3 event, the terminal may determine whether a condition for transmitting a measurement prediction report to a base station is satisfied. The terminal confirming satisfaction of the condition for transmitting the measurement prediction report to the base station may transmit a measurement prediction report including one or more measurement results and/or one or more measurement prediction results to the base station (e.g. a source base station or a source cell) at a time t₁. In other words, the terminal may determine whether the measurement prediction report is required based on the measurement prediction results according to the measurement prediction event configuration information. The terminal may transmit measurement prediction reports including the measurement prediction results to the base station based on whether the measurement prediction report is required. The measurement prediction event configuration information may be included in measurement configuration information or measurement prediction configuration information and may be received by the terminal. Alternatively, the measurement prediction event configuration information may be received independently of the measurement configuration information and the measurement prediction configuration information.

To transmit the measurement prediction report, the terminal may use a message for an existing measurement report. To transmit the measurement prediction report, the terminal may include, in the measurement prediction report, a flag indicating that the values included in the message are measurement prediction results.

After receiving the measurement prediction report, the base station may determine a target cell based on the measurement prediction report. After determining the target cell, the base station may perform handover preparation for handover to the target cell. The base station completing the handover preparation may transmit a handover command to the terminal.

The base station may transmit configuration information (e.g. measurement prediction configuration information) to the terminal so that the terminal may transmit a measurement prediction report when a specific condition is satisfied. The above-described configuration information may include a condition for the terminal to transmit the measurement prediction report to the base station. The above-described specific condition may be that a state in which the A3 event entering condition is satisfied after a specific neighboring cell satisfies the A3 event entering condition is maintained during a time t₀ trigger for prediction report (TTTP).

According to the above-described procedures, when a handover based on actual measurement results and measurement prediction results by the terminal is performed, it may be ensured that a signal strength (e.g. RSRP, RSRQ, SINR, or SNR) of a target cell is higher than a signal strength of a serving cell by an A3 offset. When a condition in which the signal strength of the target cell remains higher than that of the serving cell by the A3 offset during TTTP based on the actual measurement results by the terminal is used, handover reliability may be improved.

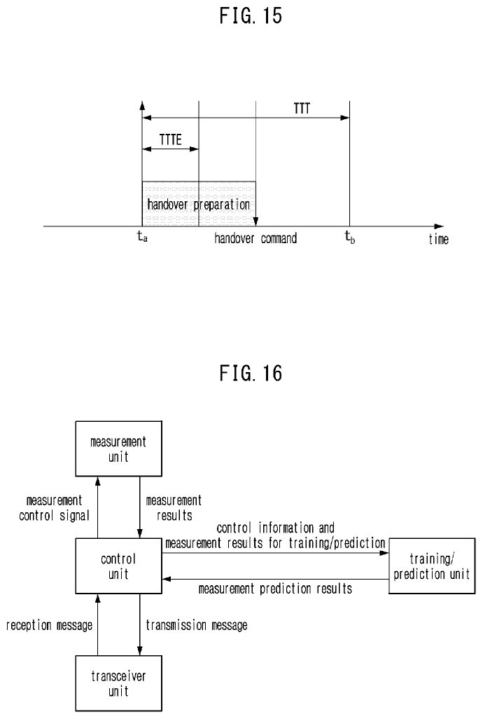

FIG. 15 is a timing diagram illustrating exemplary embodiments of a measurement prediction-based handover reliability improvement procedure.

Referring to FIG. 15, a terminal may perform measurement on a serving cell and/or neighboring cells. Through the measurement, the terminal may identify whether a specific cell satisfies an A3 event entering condition. When the terminal identifies that the specific cell satisfies the A3 event entering condition, the terminal may predict whether the A3 event is satisfied and a time at which the A3 event is satisfied at a time tₐ. In other words, the terminal may configure a specific condition included in measurement prediction configuration information. The terminal may determine whether the specific condition is satisfied. The terminal may perform measurement prediction when the specific condition is satisfied. The terminal may predict that the A3 event is satisfied at a time t_{b}.

The terminal performing A3 event prediction may transmit a measurement prediction report including one or more measurement results and/or one or more measurement prediction results to a base station (e.g. a source base station or a source cell). In other words, the terminal may determine whether a measurement prediction report is required based on the measurement prediction results according to the measurement prediction event configuration information. The terminal may transmit measurement prediction reports including the measurement prediction results to the base station based on whether the measurement prediction report is required. The measurement prediction event configuration information may be included in measurement configuration information or measurement prediction configuration information and may be received by the terminal. Alternatively, the measurement prediction event configuration information may be received independently of the measurement configuration information and the measurement prediction configuration information.

To transmit the measurement prediction report, the terminal may use a message for an existing measurement report. To transmit the measurement prediction report, the terminal may include, in the measurement prediction report, a flag indicating that the values included in the message are measurement prediction results.

After receiving the measurement prediction report, the base station may determine a target cell (or a target base station) based on the measurement prediction report. The base station determining the target cell may perform handover preparation for handover to the target cell. The base station completing the handover preparation may transmit a handover command to the terminal. The terminal receiving the handover command may determine whether a handover execution condition is satisfied. The terminal confirming satisfaction of the handover execution condition may perform handover to the target cell. For example, the handover execution condition may be that, based on measurement results, a specific neighboring cell satisfies the A3 event entering condition and a state in which the A3 event entering condition is satisfied is maintained during a time t₀ trigger for execution (TTTE). TTTE may be shorter than a handover preparation period.

The base station may transmit configuration information (e.g. measurement prediction configuration information) to the terminal so that the terminal performs handover when a handover execution condition is satisfied after the terminal receives a handover command. The above-described configuration information may include the handover execution condition. Alternatively, the handover execution condition may be included in the handover command.

The terminal performing handover based on satisfaction of the handover execution condition may transmit, to the base station, a message indicating that the handover execution condition is satisfied before performing the handover. The base station may transmit configuration information (e.g. measurement prediction configuration information) to the terminal so that the terminal transmits a message indicating that the handover execution condition is satisfied to the base station before performing the handover. Alternatively, transmitting a message indicating that the handover execution condition is satisfied to the base station before performing the handover may be configured for the terminal by the handover command. Transmitting a message indicating that the handover execution condition is satisfied to the base station before performing the handover may be configured by reportOnExecutionConditionsMet in the measurement prediction configuration information or the handover command.

The terminal that does not perform handover due to non-satisfaction of the handover execution condition may transmit, to the base station, a message indicating that the handover execution condition is not satisfied. The above-described message may include one or more measurement results generated by the terminal. The base station may transmit configuration information (e.g. measurement prediction configuration information) to a terminal so that the terminal transmits a message indicating that the handover execution condition is not satisfied to the base station. Alternatively, transmitting a message indicating that the handover execution condition is not satisfied to the base station may be configured for the terminal by the handover command. Transmitting a message indicating that the handover execution condition is not satisfied to the base station may be configured by reportOnExecutionConditionsNotMet in the measurement prediction configuration information or the handover command.

The terminal that does not perform handover due to non-satisfaction of the handover execution condition may continuously check whether the handover execution condition is satisfied. The terminal confirming satisfaction of the handover execution condition through continuous checking may perform handover to the target cell according to the received handover command. The base station may transmit configuration information (e.g. measurement prediction configuration information) to a terminal so that the terminal continuously checks whether the handover execution condition is satisfied when the terminal does not perform handover due to non-satisfaction of the handover execution condition. Alternatively, continuously checking whether the handover execution condition is satisfied due to non-satisfaction of the handover execution condition may be configured for the terminal by the handover command. Continuously checking whether the handover execution condition is satisfied due to non-satisfaction of the handover execution condition may be configured by continueEvaluationAfterExecutionConditionsNotMet in the measurement prediction configuration information or the handover command.

The terminal may transmit, to the base station, a message indicating satisfaction of the handover execution condition after confirming satisfaction of the handover execution condition through continuous checking and before performing the handover. The base station may configure the terminal, through configuration information (e.g. measurement prediction configuration information), to transmit a message indicating satisfaction of the handover execution condition before performing the handover after confirming satisfaction of the handover execution condition through continuous checking. Alternatively, the base station may configure the terminal, through the handover command, to transmit a message indicating satisfaction of the handover execution condition before performing the handover after confirming satisfaction of the handover execution condition through continuous checking. Transmission of a message indicating satisfaction of the handover execution condition, after confirming the satisfaction through continuous checking and before performing the handover, may be configured by prediction reportOnExecutionConditionsMetAfterContinueEvaluation in the measurement configuration information or the handover command.

According to the above-described procedures, when handover based on actual measurement results and measurement prediction results by the terminal is performed, it may be ensured that a signal strength (e.g. RSRP, RSRQ, SINR, or SNR) of a target cell is higher than a signal strength of a serving cell by an A3 offset. When a condition in which the signal strength of the target cell remains higher than that of the serving cell by the A3 offset during TTTE based on the actual measurement results by the terminal is used, handover reliability may be improved.

FIG. 16 is a conceptual diagram illustrating exemplary embodiments of blocks included in a terminal.

Referring to FIG. 16, functional blocks included in a terminal performing measurement reporting and/or measurement prediction reporting may be identified. The functional blocks may function for measurement reporting and/or measurement prediction reporting by the terminal. A role of each of the functional blocks is described below.

A transceiver unit may deliver a message (e.g. RRC reconfiguration message) received from a base station to a control unit. The control unit may deliver measurement control information (e.g. measurement configuration information) to a measurement unit according to an instruction of the received message. Alternatively, the control unit may deliver measurement control information included in the received message to the measurement unit. The measurement unit may perform measurement on a serving cell and neighboring cells according to the measurement control information. Through measurement on the serving cell and the neighboring cells, the measurement unit may generate measurement results. The measurement unit may deliver the measurement results to the control unit. The control unit may deliver the received measurement results and control information for training and prediction (e.g. measurement prediction configuration information) to a training/prediction unit. The training/prediction unit may perform measurement prediction on the serving cell and the neighboring cells using the measurement results according to the control information for training and prediction. The training/prediction unit may generate measurement prediction results through measurement prediction on the serving cell and the neighboring cells. The training/prediction unit may deliver the measurement prediction results to the control unit.

The control unit may generate one or more measurement reports and/or one or more measurement prediction reports based on the measurement results and/or the measurement prediction results. The control unit may transmit the one or more measurement reports and/or the one or more measurement prediction reports to the base station. The measurement unit may be responsible for radio resource management (RRM) measurement, a radio link monitor process, and a handover process. The training/prediction unit may be responsible for an RRM measurement prediction process, a radio link failure (RLF) prediction process, a prediction process for a measurement report event, and a prediction process for a measurement prediction report event.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, the method comprising:
receiving measurement configuration information from a base station;
receiving measurement prediction configuration information from the base station;
receiving measurement prediction report event configuration information from the base station;
performing measurement on a serving cell and neighboring cells based on the measurement configuration information to generate measurement results;
performing measurement prediction on the serving cell and the neighboring cells based on the measurement prediction configuration information to generate measurement prediction results;
determining whether a measurement prediction report is required based on the measurement prediction results according to the measurement prediction report event configuration information; and
transmitting, to the base station, a measurement prediction report including the measurement prediction results based on whether the measurement prediction report is required.

2. The method of claim 1, further comprising:
before generating the measurement prediction results, configuring a first condition included in the measurement prediction configuration information, the first condition being a condition for performing the measurement prediction; and
determining whether the first condition is satisfied,
wherein the measurement prediction results are generated based on whether the first condition is satisfied.

3. The method of claim 2, wherein the first condition is satisfied based on that the measurement results satisfy a second condition.

4. The method of claim 3, wherein the second condition is satisfied based on that the measurement results satisfy an entering condition of a measurement report event indicated by the measurement report event configuration information.

5. The method of claim 1, further comprising: before transmitting the measurement prediction report, determining whether a third condition included in the measurement prediction configuration information is satisfied,
wherein the measurement prediction report is transmitted based on satisfaction of the third condition.

6. The method of claim 5, wherein the third condition is satisfied based on that the measurement results and the measurement prediction results satisfy a fourth condition.

7. The method of claim 1, wherein the measurement prediction report includes at least one of whether a measurement report event indicated by the measurement report event configuration information is satisfied or a time at which the measurement report event is satisfied.

8. The method of claim 2, further comprising:
receiving, from the base station, a handover command based on the measurement prediction report;
checking whether satisfaction of the first condition is maintained for a first time; and
performing a handover according to the handover command based on whether the satisfaction of the first condition is maintained for the first time.

9. A method of a base station, the method comprising:
transmitting, to a terminal, measurement configuration information including measurement report event configuration information;
transmitting measurement prediction configuration information to the terminal;
receiving, from the terminal, a measurement prediction report including measurement prediction results generated based on the measurement prediction configuration information; and
transmitting a handover command to the terminal based on the measurement prediction results.

10. The method of claim 9, wherein the measurement prediction configuration information includes a first condition for the terminal to perform measurement prediction, and the measurement prediction results are generated based on satisfaction of the first condition.

11. The method of claim 10, wherein the first condition is satisfied based on that measurement results generated based on the measurement configuration information satisfy a second condition.

12. The method of claim 11, wherein the second condition is satisfied based on that the measurement results satisfy an entering condition of a measurement report event indicated by the measurement report event configuration information.

13. The method of claim 9, wherein the measurement prediction configuration information includes a third condition, and the measurement prediction report is received based on satisfaction of the third condition.

14. The method of claim 13, wherein the third condition is satisfied based on that the measurement results and the measurement prediction results satisfy a fourth condition.

15. The method of claim 14, wherein the measurement prediction report includes at least one of whether a measurement report event indicated by the measurement report event configuration information is satisfied or a time at which the measurement report event is satisfied.

16. A terminal comprising at least one processor, wherein the at least one processor causes the terminal to perform:
receiving measurement configuration information from a base station;
receiving measurement prediction configuration information from the base station;
receiving measurement prediction report event configuration information from the base station;
performing measurement on a serving cell and neighboring cells based on the measurement configuration information to generate measurement results;
performing measurement prediction on the serving cell and the neighboring cells based on the measurement prediction configuration information to generate measurement prediction results;
determining whether a measurement prediction report is required based on the measurement prediction results according to the measurement prediction report event configuration information; and
transmitting, to the base station, a measurement prediction report including the measurement prediction results based on whether the measurement prediction report is required.

17. The terminal of claim 16,
wherein the at least one processor further causes the terminal to perform: before generating the measurement prediction results, determining whether a first condition included in the measurement prediction configuration information is satisfied,
wherein the first condition is a condition for performing the measurement prediction, and the measurement prediction results are generated based satisfaction of the first condition.

18. The terminal of claim 17, wherein the first condition is satisfied based on that the measurement results satisfy a second condition.

19. The terminal of claim 18, wherein the second condition is satisfied based on that the measurement results satisfy an entering condition of a measurement report event indicated by the measurement report event configuration information.

20. The terminal of claim 16, wherein the at least one processor further causes the terminal to perform:
before transmitting the measurement prediction report, determining whether a third condition included in the measurement prediction configuration information is satisfied; and
determining whether the measurement prediction report is required for the base station,
wherein the measurement prediction report is transmitted based on satisfaction of the third condition and based on the measurement prediction report being required for the base station.
